(19) United States
(12) Patent Application Publication
(10) Pub. No.: US 2003/0097281 A1
(43) Pub. Date: May 22, 2003

(54) Expense estimation method, program and device with a bantering estimation prevention function

(75) Inventor: Nao Momose, Yokohama (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/112,864

(22) Filed: Apr. 2, 2002

(30) Foreign Application Priority Data
Nov. 22, 2001 (JP) 2001-357906

(51) Int. Cl. G06F 17/60

(52) U.S. Cl. 705/4

(57) ABSTRACT

An expense estimation device comprising storage means, comparing means, and judging means. The storage means stores address information in association with information related to the address information. The comparing means compares each of items contained in estimation information with the information stored in the storage means, when the estimation information is received. The items contained in the estimation information include at least address information and information related to the address information. According to a result of the comparison made by the comparing means, the judging means judges whether or not an estimation is possible, based on an association between the address information and the information related to the address information contained in the estimation information.

### BACKGROUND OF THE INVENTION

1. Field of the Invention

The present invention generally relates to an expense estimation device, program and method, and more particularly, to an expense estimation device, program and method for estimating expenses, such as an insurance premium.

2. Description of the Related Art

Conventionally, there is a system for estimating expenses for an automobile insurance and so forth by accessing a server (an expense estimation server) having a function of estimating such expenses, from a terminal device, such as a personal computer or a mobile phone, via a network, such as the Internet.

This system has the following merits: a user can easily estimate expenses required for goods or services, from a personal computer at home or a mobile phone, without a help of another person; a company providing these goods or services can operate the business without wasting man power.

However, according to a configuration of the conventional system, since users can easily try estimations, the system is used also by many “banterers” just estimating without a faithful commitment to making a contract. These “bantering” estimations impose an unnecessary load upon the expense estimation server so as to prolong a processing time for estimation.

In order to decrease these “bantering” estimations, it is conceivable to necessitate input of user-specific items, such as an address, for performing the estimation. However, the estimation can be performed only by inputting any information in these items. Therefore, this measure lacks fundamental effect on the prevention of the “bantering” estimations.

Especially, the “bantering users” often input pseudo user information, for reasons such as “to hide” or “to prevent a cumbersome task of inputting correct information, such as an address”. Accordingly, thereafter, when a manager tries to provide goods or services to this user, the manager has to face a situation that the user does not actually exist. To prevent this, the manager has to provide goods or services while verifying whether input information is true or not, among estimation information containing lots of pseudo information. This, on the contrary, wastes man power.

### SUMMARY OF THE INVENTION

It is a general object of the present invention to provide an improved and useful expense estimation device, program and method, in which the above-mentioned problems are eliminated.

A more specific object of the present invention is to provide an expense estimation device, program and method which can recognize a user supposed to be a banterer.

In order to achieve the above-mentioned objects, there is provided according to the present invention an expense estimation device, program and method having a function of accumulatively storing information input upon bantering estimations, and comparing items included in information input upon a present estimation with the stored banter information so as to judge the present estimation as a bantering estimation when the present information includes more than a predetermined number of items corresponding to the stored banter information. Thereby, a user can be supposedly judged to be whether or not a banterer. Determining whether or not to perform an estimation according to this judgment eliminates an unnecessary estimative calculation so as not to waste a processing capacity for a bantering estimation. Additionally, this provides users with an idea that the above-mentioned function does not allow bantering estimations. This idea reduces the number of banterers accessing the expense estimation device, and thus reduces a load of the expense estimation device. Further, decreasing the number of bantering estimations reduces a possibility of pseudo information being input as contractor information.

Other objects, features and advantages of the present invention will become more apparent from the following detailed description when read in conjunction with the accompanying drawings.

### BRIEF DESCRIPTION OF THE DRAWINGS

FIG. 1 is a diagram of an entire configuration of an expense estimation system according to an embodiment of the present invention;

FIG. 2 is a block diagram of a configuration of a server shown in FIG. 1;

FIG. 3 is an illustration of tables stored in a banter information storage unit shown in FIG. 2;

FIG. 4 illustrates a table stored in a telephone number information storage unit shown in FIG. 2 and a table stored in a zip code number information storage unit shown in FIG. 2;

FIG. 5 illustrates a file stored in a contractor information storage unit shown in FIG. 2;

FIG. 6 is a block diagram of a configuration of a user computer shown in FIG. 1;

FIG. 7 is a block diagram of a configuration of an administration computer shown in FIG. 1;

FIG. 8 is a block diagram of a configuration of a mobile phone shown in FIG. 1;

FIG. 9 to FIG. 11 are main flowcharts according to the present embodiment;

FIG. 12 illustrates an estimation input screen displayed on a display of the user computer according to the present embodiment;

FIG. 13 is a flowchart of a re-input process performed when an estimation input includes an input error, according to the present embodiment;

FIG. 14 illustrates an input error screen and an impossible estimation screen displayed on the display of the user computer according to the present embodiment;

FIG. 15 is a flowchart of a process of judging whether or not information input by a user is of banter, according to the present embodiment;

FIG. 16 is a flowchart of a process performed upon an impossible estimation according to the present embodiment;

FIG. 17 illustrates an estimation result screen on the display of the user computer according to the present embodiment;

FIG. 18 is a flowchart of a process performed upon a failure of a contract, according to the present embodiment;

FIG. 19 illustrates a contract failure screen output on the display of the user computer according to the present embodiment;

FIG. 20 is a flowchart of a process performed when an input contract information includes an input error, according to the present embodiment;

FIG. 21 illustrates a contract-information input screen and a contract completion screen displayed on the display of the user computer according to the present embodiment; and

FIG. 22 illustrates a screen displayed on a display of an administration computer shown in FIG. 1 according to the present embodiment.

### DETAILED DESCRIPTION OF THE PREFERRED EMBODIMENTS

A description will now be given, with reference to the drawings, of an embodiment according to the present invention. The description of the present embodiment will be made on an example of estimating an automobile insurance.

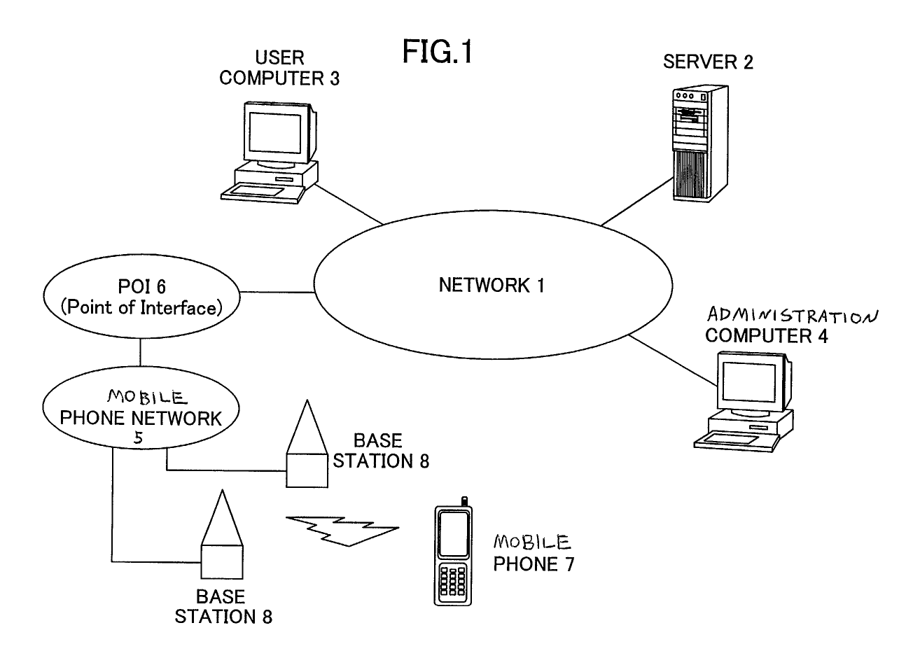

FIG. 1 is a diagram of an entire configuration of an expense estimation system according to the present embodiment. A network 1 is a network, such as the Internet. A server 2 has an expense estimation function. A user computer 3 is used by a user performing an estimation. An administration computer 4 administers the server 2. The server 2, the user computer 3 and the administration computer 4 are connected to the network 1.

A mobile phone network 5 is connected to the network 1 via a point of interface 6. A mobile phone 7 is connected to the mobile phone network 5 via a base station 8. The mobile phone 7 can communicate, via the mobile phone network 5, with another mobile phone, and with various apparatuses connected to the network 1.

Hereinbelow, descriptions will be given of each of the elements of the above-mentioned expense estimation system.

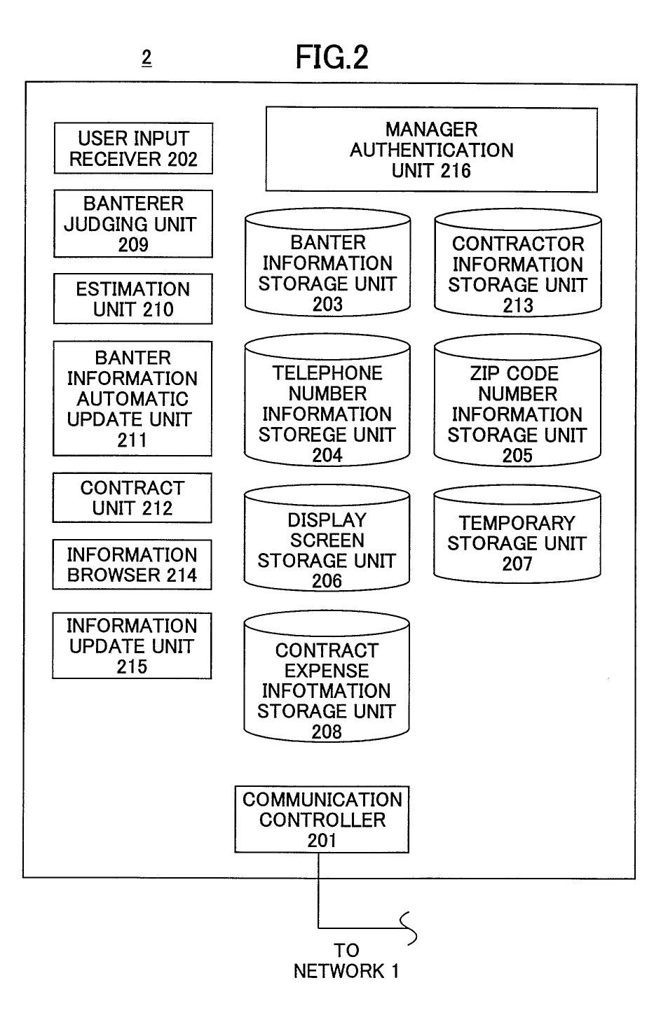

First, a description will be given, with reference to FIG. 2, of a configuration of the server 2. FIG. 2 is a block diagram of the configuration of the server 2.

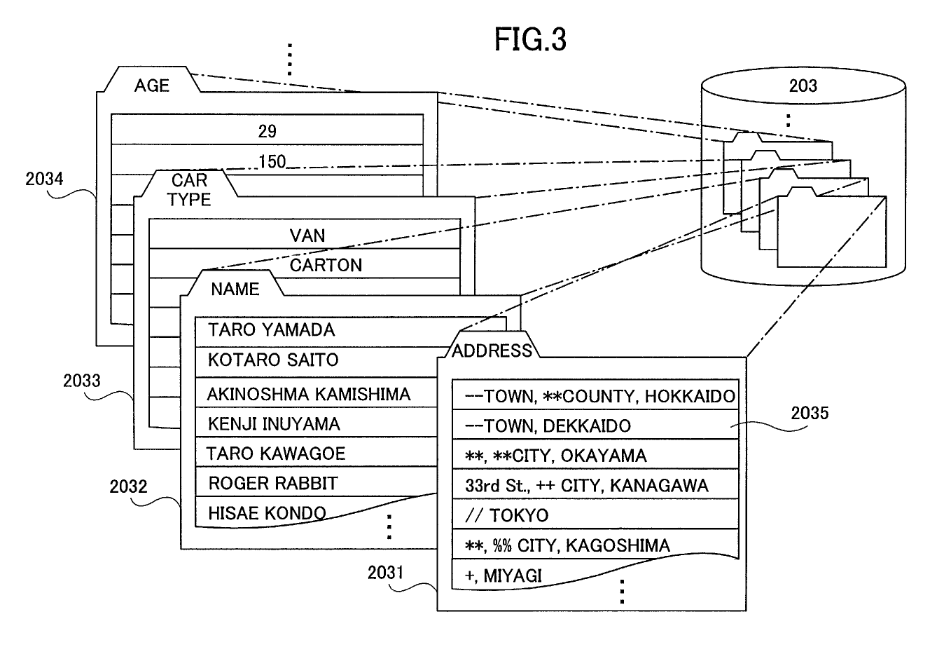

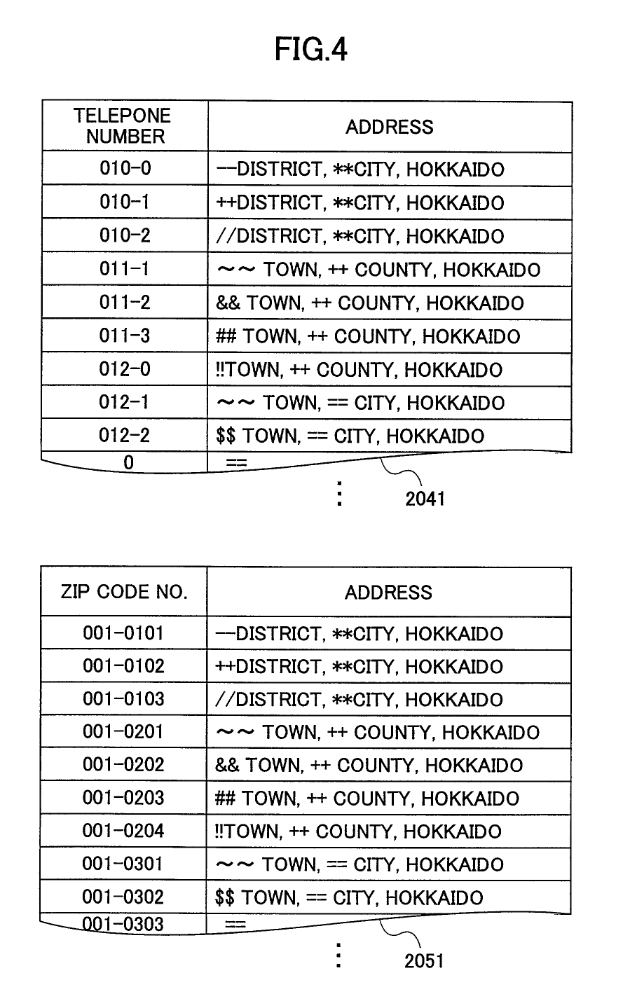

In FIG. 2, a communication controller 201 is connected to the network 1, and communicates with another apparatus via the network 1. The server 2 performs a communication by using this communication controller 201. A user input receiver 202 receives an input from a user, and receives an input including a plurality of items from the user computer 3 via the network 1. A banter information storage unit 203 stores information used when a user performs a bantering estimation. As shown in FIG. 3, the banter information storage unit 203 comprises tables 2031 to 2034 storing each of the items input from the user input receiver 202. The tables 2031 to 2034 of the banter information storage unit 203 store intact information input by the user. For example, the table 2031 stores actually inexistent information 2035 as it is. A telephone number information storage unit 204 stores first four digits of telephone numbers in association with address information, as shown in a table 2041 in FIG. 4. A zip code number information storage unit 205 stores zip code numbers in association with the address information, as shown in a table 2051 in FIG. 4. A display screen storage unit 206 stores screen information for causing the user computer 3 or the administration computer 4 to display for each situation during a communication. A temporary storage unit 207 stores information to be temporarily stored during a process. Though not mentioned specifically in a hereinafter-described functional description, the temporary storage unit 207 temporarily stores estimation information or contract information transmitted from the user computer 3 or the mobile phone 7. A contract expense information storage unit 208 stores various information used in calculating a contract expense.

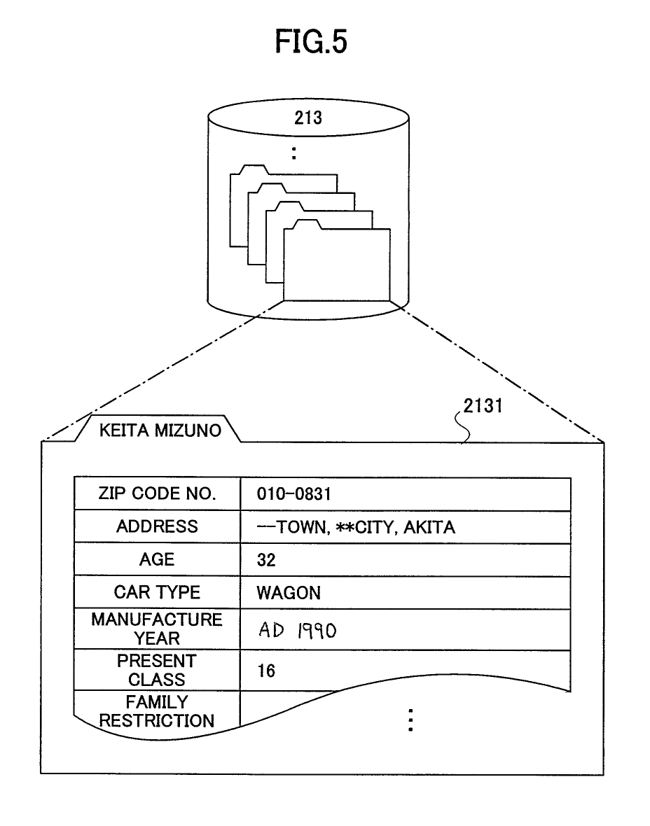

A banterer judging unit 209 judges from user information received by the user input receiver 202 whether or not a user is a banterer, by utilizing the information stored in the banter information storage unit 203, the telephone number information storage unit 204 and the zip code number information storage unit 205. An estimation unit 210 estimates an insurance premium according to the user information received by the user input receiver 202, by referring to the information stored in the contract expense information storage unit 208. A banter information automatic update unit 211 adds to the banter information storage unit 203, user information of a user who does not make an actual contract after an estimation made by the estimation unit 210 is transmitted to the user computer 3. A contract unit 212 causes a contractor information storage unit 213 to store user information after receiving input information necessary for making a contract, upon making an actual contract. The contractor information storage unit 213 is controlled by the contract unit 212 so as to store the user information on an individual contractor basis, as shown in a file 2131 in FIG. 5. An information browser 214 retrieves contractor information in response to a request from the administration computer 4 so as to transmit the contractor information to the administration computer 4. An information update unit 215 updates information in the banter information storage unit 203 in response to a request from the administration computer 4. A manager authentication unit 216 authenticates a manager prior to making various requests from the administration computer 4.

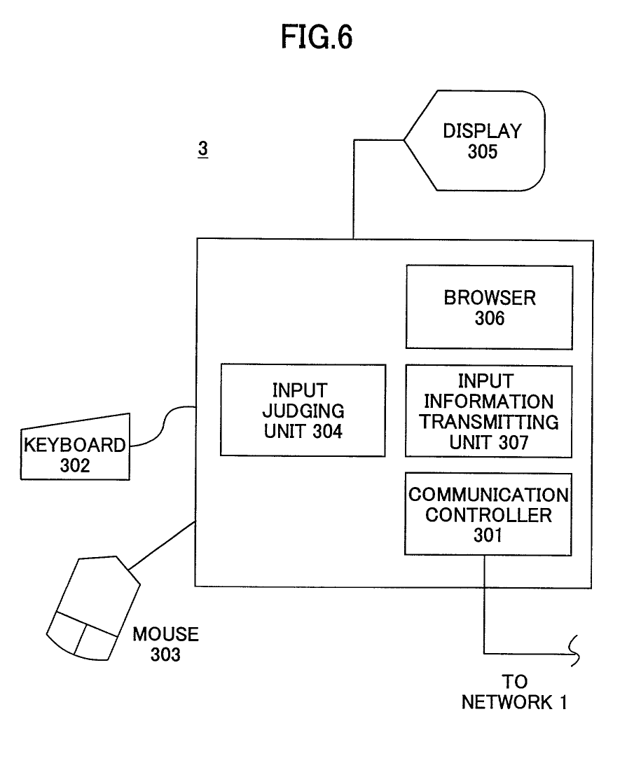

Next, a description will be given, with reference to FIG. 6, of a configuration of the user computer 3. FIG. 6 is a block diagram of the configuration of the user computer 3.

In FIG. 6, a communication controller 301 is connected to the network 1, and communicates with another apparatus via the network 1. The user computer 3 performs a communication by using this communication controller 301. An input judging unit 304 judges inputs from a keyboard 302 and a mouse 303 so as to display input information on a display 305. A browser 306 displays various screen information transmitted from the server 2 on the display 305. An input information transmitting unit 307 transmits the input information input by using the keyboard 302 and the mouse 303 to the server 2.

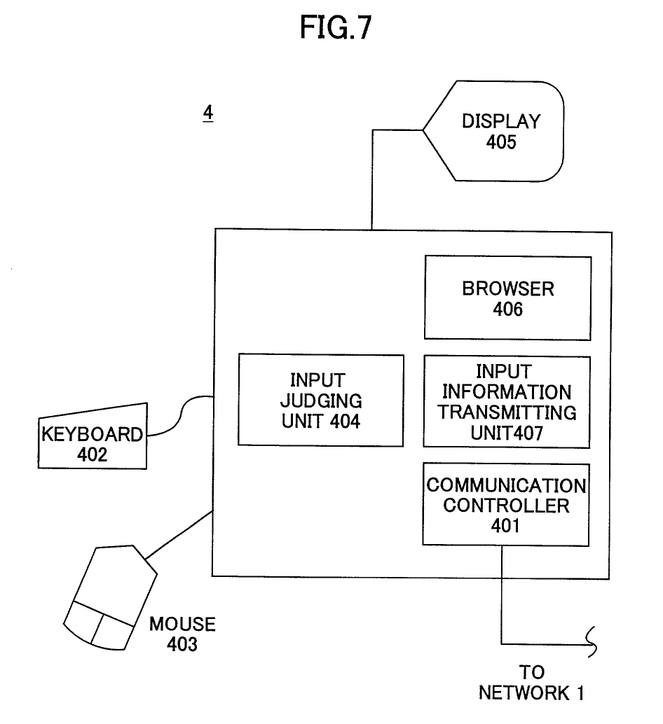

Next, a description will be given, with reference to FIG. 7, of a configuration of the administration computer 4. FIG. 7 is a block diagram of the configuration of the administration computer 4.

In FIG. 7, a communication controller 401 is connected to the network 1, and communicates with another apparatus via the network 1. The administration computer 4 performs a communication by using this communication controller 401. An input judging unit 404 judges inputs from a keyboard 402 and a mouse 403 so as to display input information on a display 405. A browser 406 displays various screen information transmitted from the server 2 on the display 405. An input information transmitting unit 407 transmits the input information input by using the keyboard 402 and the mouse 403 to the server 2. As described above, the administration computer 4 has substantially the same configuration as the user computer 3.

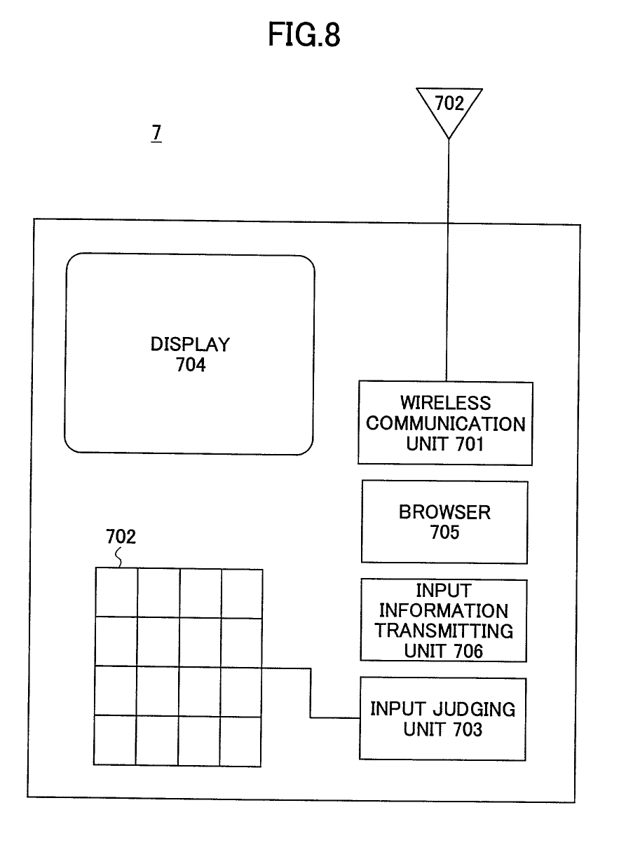

Finally, a description will be given, with reference to FIG. 8, of a configuration of the mobile phone 7. FIG. 8 is a block diagram of the configuration of the mobile phone 7.

In FIG. 8, a wireless communication unit 701 is connected to an antenna 702 so as to access the mobile phone network 5 via the base station 8. As described above, since the mobile phone network 5 is connected to the network 1 via the point of interface 6, the mobile phone 7 can communicate with the server 2 by controlling the wireless communication unit 701. An input judging unit 703 judges an input from a keyboard 702 so as to display input information on a display 704. A browser 705 displays various screen information transmitted from the server 2 on the display 704. An input information transmitting unit 706 transmits the input information input by using the keyboard 702 to the server 2. As described above, the mobile phone 7 has substantially the same configuration as the user computer 3 except that the mobile phone 7 performs a wireless communication. Besides, in the present embodiment, an audio communication performed by the mobile phone 7 is not explained because of irrelevance to the substance of the present invention; however, the mobile phone 7 may have an audio communication function.

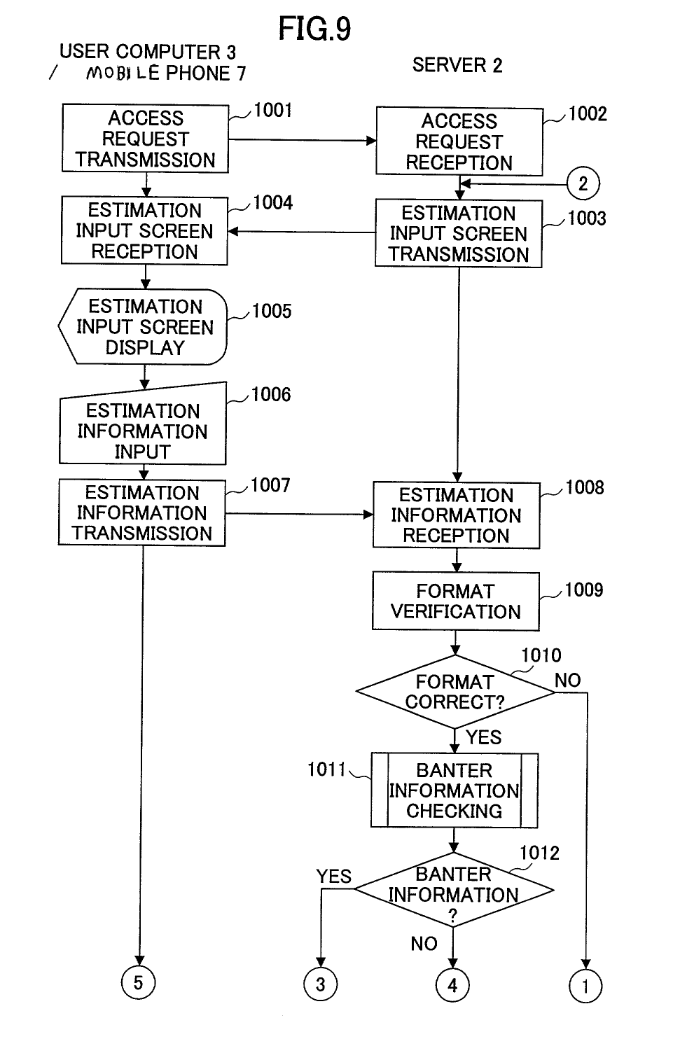

Hereinbelow, descriptions will be given, with reference to FIG. 9 to FIG. 21, of estimation and contract controls of the expense estimation system configurated as above.

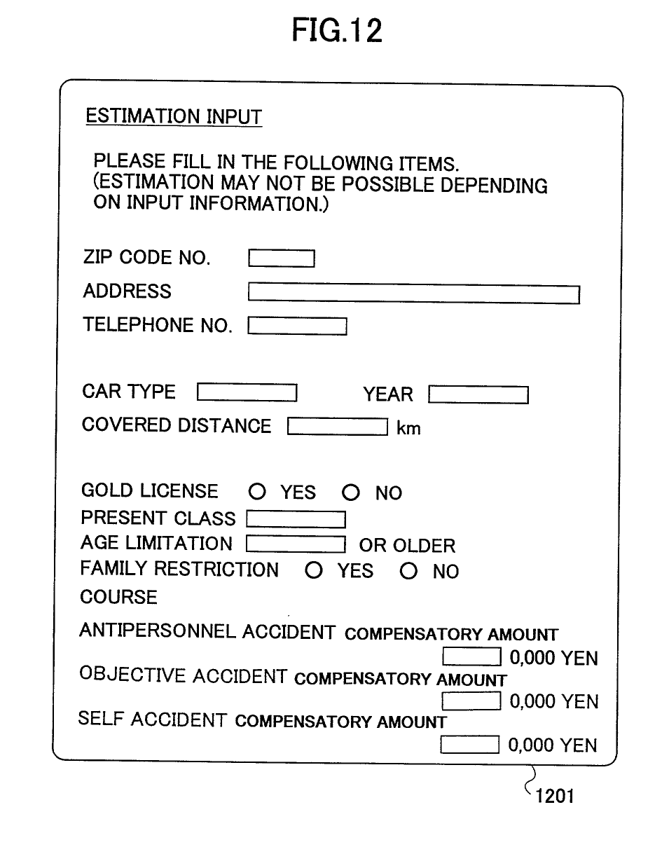

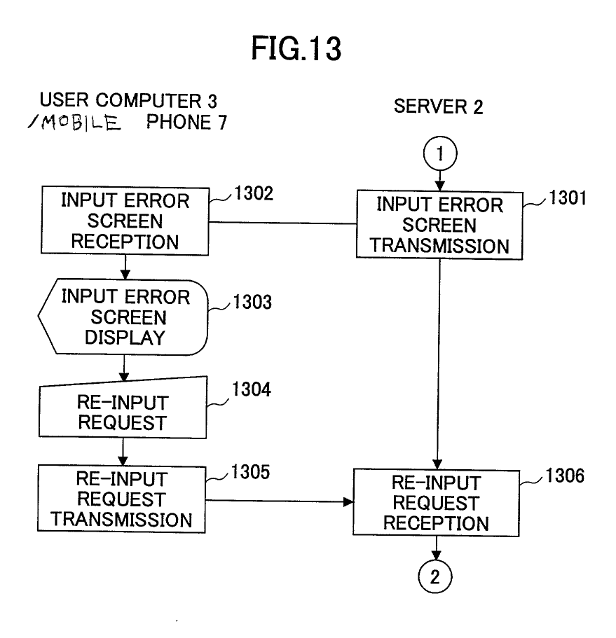

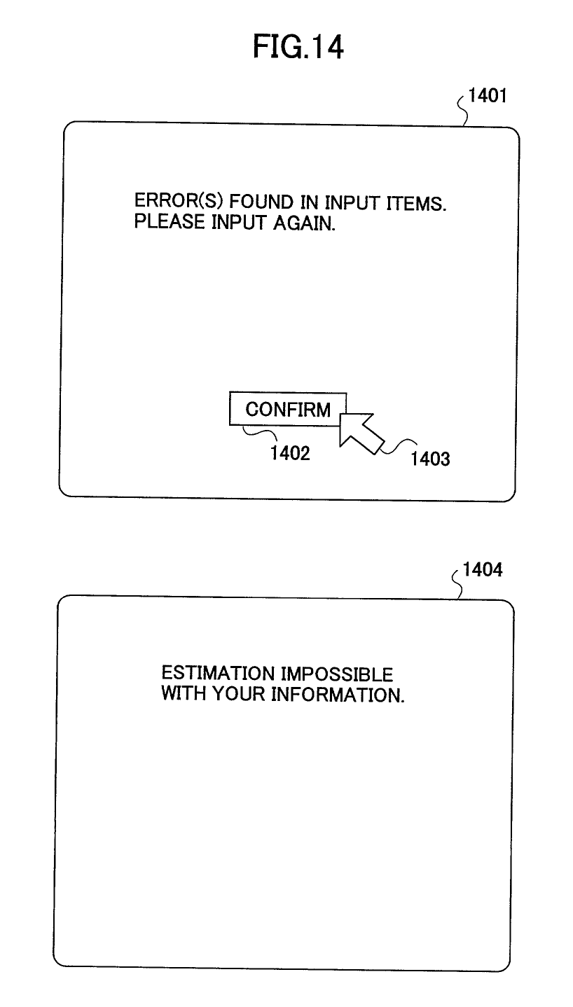

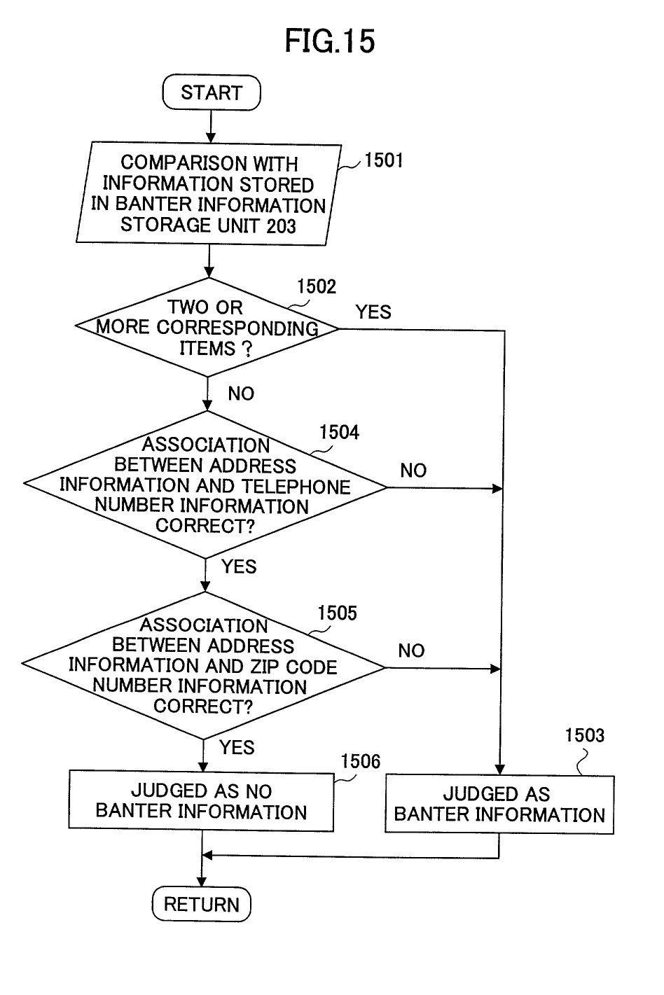

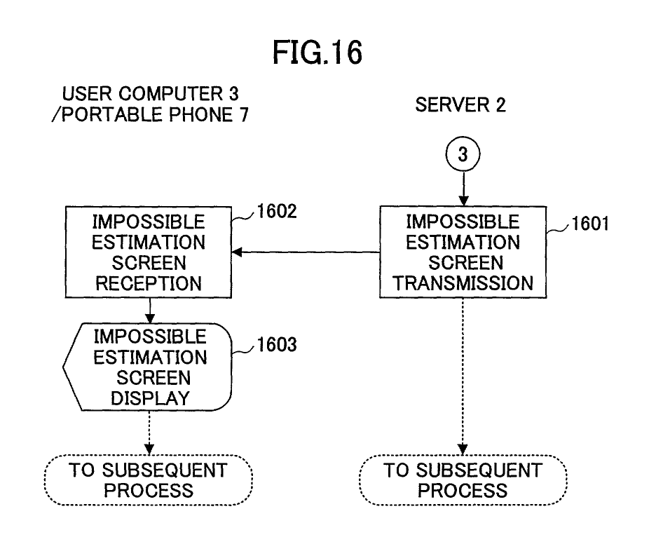

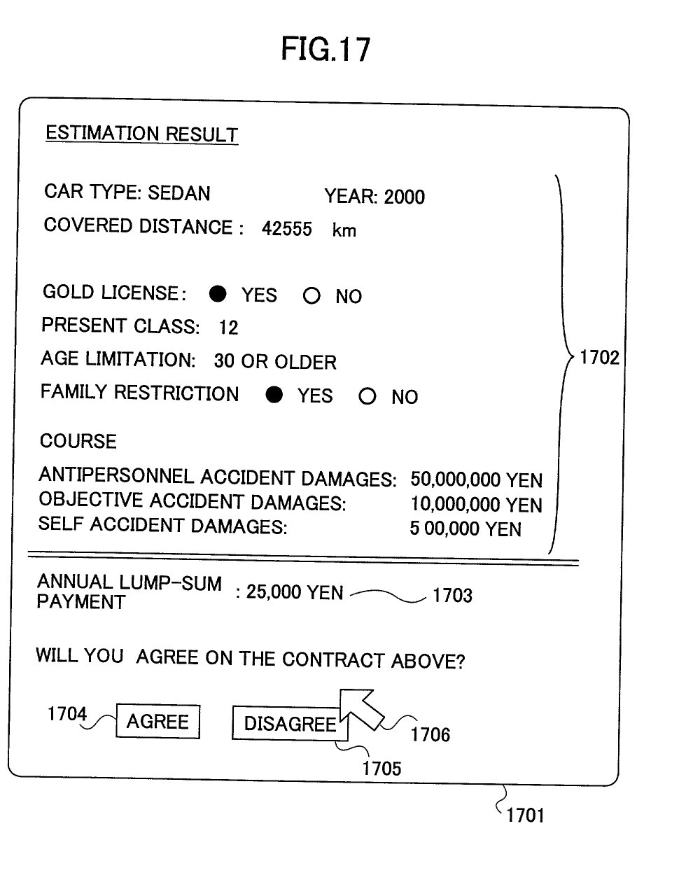

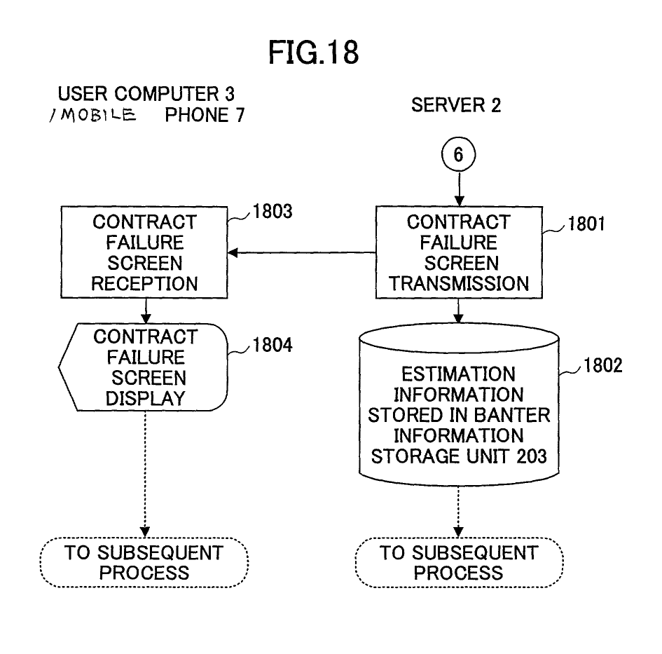

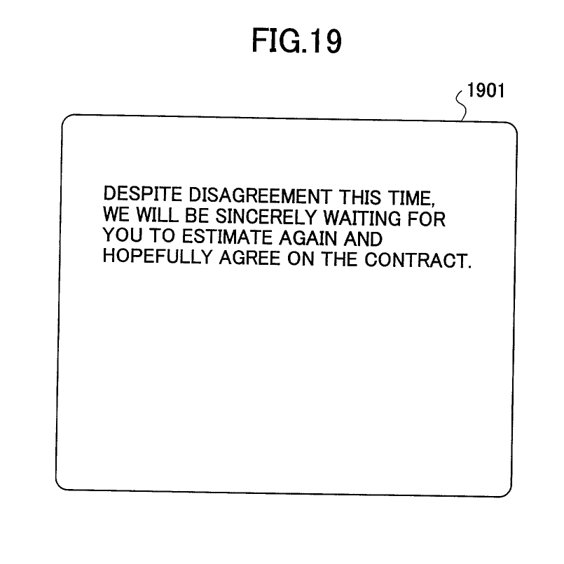

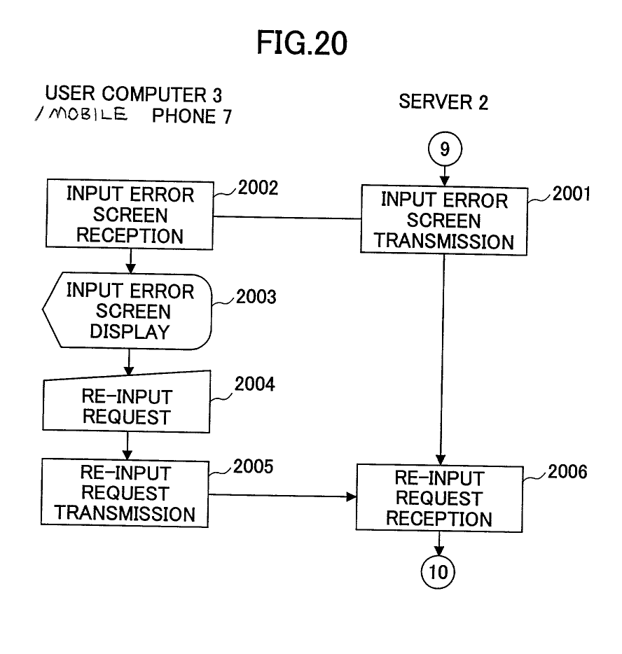

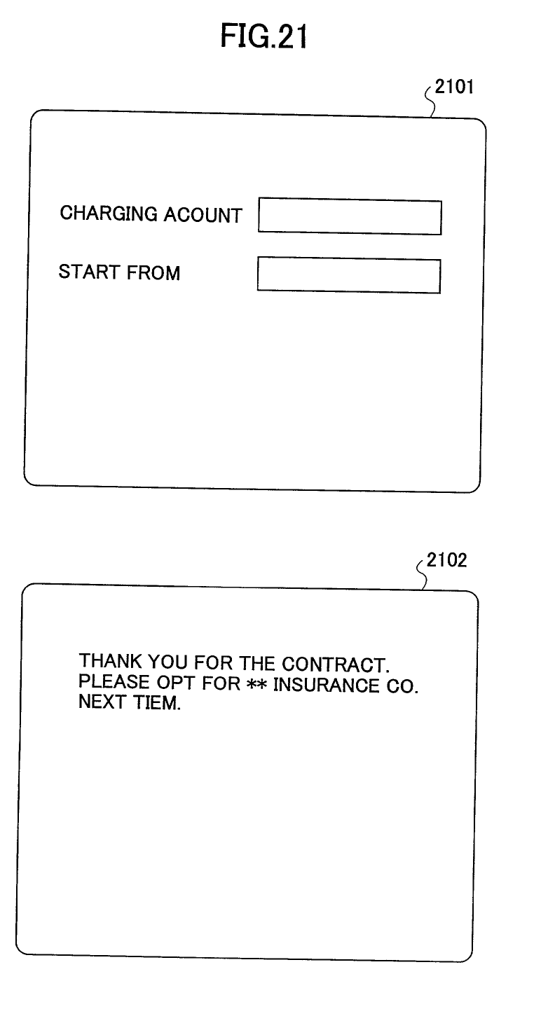

FIG. 9 to FIG. 11 are main flowcharts of the controls. FIG. 12 illustrates an estimation input screen displayed on the display 305 of the user computer 3. FIG. 13 is a flowchart of a process of prompting a re-input when an estimation input includes an input error. FIG. 14 illustrates an input error screen and an impossible estimation screen displayed on the display 305 of the user computer 3. FIG. 15 is a flowchart of a process of judging whether or not information input by a user is of banter. FIG. 16 is a flowchart of a process performed upon an impossible estimation. FIG. 17 illustrates an estimation result screen on the display 305 of the user computer 3. FIG. 18 is a flowchart of a process performed upon a failure of a contract. FIG. 19 illustrates a contract failure screen output on the display 305 of the user computer 3. FIG. 20 is a flowchart of a process performed when an input contract information includes an input error. FIG. 21 illustrates a contract-information input screen and a contract completion screen displayed on the display 305 of the user computer 3.

To begin with, a description will be given, with reference to FIG. 9, of an actual estimation process. It is noted that, although the following functional description is made on a control between the user computer 3 and the server 2, the following functional description also applies to a control between the mobile phone 7 and the server 2.

First, the user computer 3 transmits an access request to the server 2 (step 1001). This access request is made, for example, by specifying an address, such as a URL (Uniform Resource Locator), on the network by means of an Internet browser. When the server 2 receives this access request (1002), the server 2 starts the user input receiver 202. This user input receiver 202 retrieves estimation input screen information from the display screen storage unit 206, and transmits the estimation input screen information to the user computer 3 (1003). When the user computer 3 receives the estimation input screen information (1004), the browser 306 of the user computer 3 displays an estimation input screen 1201 shown in FIG. 12, based on the estimation input screen information, on the display 305 (1005). As shown in FIG. 12, the estimation input screen 1201 prompts an input of a plurality of input items. Besides, in the present embodiment, the input items include a zip code number, a telephone number and an address.

Thereafter, when the input of the input items is finished (1006), the input information is transmitted to the server 2 as estimation information (1007). When the server 2 receives the estimation information (1008), the server 2 verifies correctness of a format of each of the items of the estimation information (for example, no full size character input in an half-size character item, or no character input in a numeric item) (1009). When a format of either of the items is incorrect (N in 1010), the process transits to the process shown in FIG. 13 of prompting a re-input when an estimation input includes an input error.

In the process shown in FIG. 13, first, an input error screen information is retrieved from the display screen storage unit 206, and is transmitted to the user computer 3 (1301). When the user computer 3 receives the input error screen information (1302), the browser 306 of the user computer 3 displays an input error screen 1401 shown in FIG. 14, based on the input error screen information, on the display 305 (1303). At this point, a “confirm” icon 1402 is also displayed on the screen. Then, when the “confirm” icon 1402 is clicked by moving an icon 1403, for example, displayed on the display 305 by means of the mouse 303 so as to input information requesting a re-input (1304), the information requesting the re-input is transmitted to the server 2 (1305). When the server 2 receives this information (1306), the process transits to the step 1003 shown in FIG. 9. Thereby, the estimation input screen is redisplayed on the display 305 of the user computer 3 so that the user can re-input the estimation information.

When the server 2 verifies the correctness of the format in the step 1009 shown in FIG. 9, and the format is correct (Y in 1010), the server 2 performs a banter information checking process (1011). This banter information checking process is the process of judging whether or not the estimation information transmitted from the user computer 3 is of banter. This process is performed according to the flowchart shown in FIG. 15. Firstly in this process, the estimation information is compared with information stored in the banter information storage unit 203.

Here, a description will be given of a method of performing this comparison. As described above, the banter information storage unit 203 stores information on an individual item basis which is input when a user performs a bantering estimation. Each of the items of the estimation information is compared with the above-mentioned information input upon bantering (1501). According to results of this comparison, when it is judged that the estimation information includes two items or more corresponding to the information formerly input upon bantering (Y in 1502), it is judged that the estimation information is of banter (1503). Conversely, when it is judged that the estimation information includes less than two items corresponding to the information formerly input upon bantering (N in 1502), it is judged whether or not an association between telephone number information and address information contained in the estimation information corresponds to the association between the telephone number and the address information stored in the telephone number information storage unit 204 (1504). When the association between the telephone number information and the address information contained in the estimation information does not correspond to the association between the telephone number and the address information stored in the telephone number information storage unit 204, it is judged that the estimation information is of banter (1503). Conversely, when the association between the telephone number information and the address information contained in the estimation information corresponds to the association between the telephone number and the address information stored in the telephone number information storage unit 204, it is judged whether or not an association between zip code number information and address information contained in the estimation information corresponds to the association between the zip code number and the address information stored in the zip code number information storage unit 205 (1505). When the association between the zip code number information and the address information contained in the estimation information does not correspond to the association between the zip code number and the address information stored in the zip code number information storage unit 205, it is judged that the estimation information is of banter (1503). Conversely, when the association between the zip code number information and the address information contained in the estimation information corresponds to the association between the zip code number and the address information stored in the zip code number information storage unit 205, it is judged that the estimation information is not of banter (1506).

In FIG. 9, when it is judged according to the banter information checking process in the step 1011 that the estimation information is banter information (Y in 1012), the server 2 transmits an impossible estimation screen information from the display screen storage unit 206 to the user computer 3 (1601), as shown in the flowchart of FIG. 16. When the user computer 3 receives the impossible estimation screen information (1602), the browser 306 of the user computer 3 displays an impossible estimation screen 1404 as shown in FIG. 14, based on the impossible estimation screen information, on the display 305 (1603). Then, the server 2 and the user computer 3 transit to respective processes.

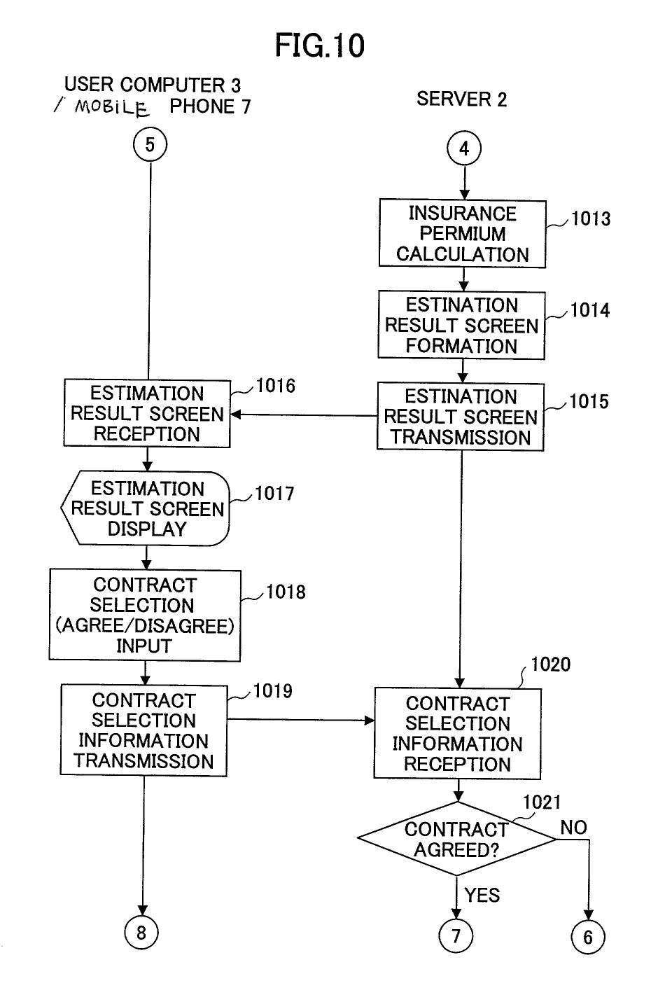

In FIG. 9, when it is judged that the estimation information is not banter information (N in 1012), the process of the server 2 transits to step 1013 shown in FIG. 10. In this step 1013, an actual insurance premium is calculated from the estimation information and various information stored in the contract expense information storage unit 208. Upon completion of this calculating step, the insurance premium calculated in the step 1013 is inserted into estimation result screen information stored in the display screen storage unit 206 so as to form the estimation result screen information to be transmitted to the user computer 3 (1014). Upon completion of the step 1014, the server 2 transmits the estimation result screen information to the user computer 3 (1015). When the user computer 3 receives the estimation result screen information (1016), the user computer 3 displays an estimation result screen 1701 as shown in FIG. 17, based on the estimation result screen information, on the display 305 (1017). The estimation result screen 1701 displays the estimation information (1702) input by the user, the insurance premium (1703) calculated in the step 1013, and icons 1704 and 1705 selected to indicate an agreement or a disagreement on making a contract with the displayed contract details.

At this point, when the input judging unit 304 judges that an input concerning the selection of making the contract or not has been made by means of the mouse 303 or the keyboard 302 (this judgment is performed by selecting the icon 1704 or 1705 with a cursor 1706 moved by operating the mouse 303) (1018), the user computer 3 transmits this contract selection information to the server 2 (1019). When the server 2 receives this contract selection information (1020), the server 2 judges whether or not this contract selection information indicates an agreement on making the contract (1021). When the server 2 judges that this contract selection information indicates a disagreement on making the contract (N in 1021), the process transits to the process shown in the flowchart of FIG. 18. In the process shown in the flowchart of FIG. 18, first, the server 2 retrieves contract failure screen information stored in the display screen storage unit 206, and transmits the contract failure screen information to the user computer 3 (1801). In addition, the server 2 stores the items of the estimation information in the respective tables provided in the banter information storage unit 203 (1802), and transmits to another process.

When the user computer 3 receives the contract failure screen information from the server 2 (1803), the user computer 3 displays a contract failure screen 1901 indicating the failure of the contract as shown in FIG. 19, based on the contract failure screen information, on the display 305 (1804).

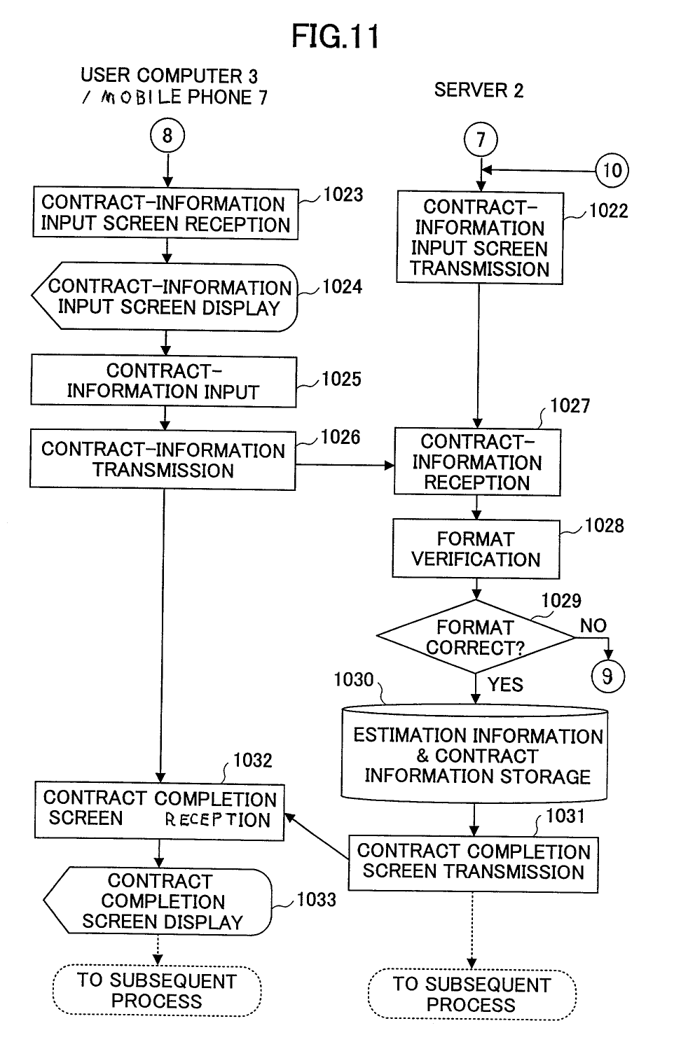

In the step 1021 shown in FIG. 10, when the server 2 judges that the contract selection information indicates an agreement on making the contract (Y in 1021), the process transits to step 1022 shown in the flowchart of FIG. 11. In the step 1022, the server 2 retrieves contract-information input screen information from the display screen storage unit 206, and transmits the contract-information input screen information to the user computer 3. When the user computer 3 receives the contract-information input screen information from the server 2 (1023), the user computer 3 displays a contract-information input screen 2101 shown in FIG. 21, based on the contract-information input screen information, on the display 305 (1024). As shown FIG. 21, the contract-information input screen 2101 is an input screen used for inputting information, not necessary for an estimation, but necessary for a contract, such as a charging account. When the input judging unit 304 judges that the user has input the contract information by using the keyboard 302 or the mouse 303 (1025), the user computer 3 transmits the input contract information to the server 2 (1026). When the server 2 receives this contract information (1027), the server 2 verifies correctness of an input format of the contract information (1028). This format verifying step 1028 is performed in the same manner as in the above-described format verification in the step 1009: e.g., no full size character is input in an half-size character item, or no character is input in a numeric item. When it is judged according to a result of the format verifying step 1028 that the format of the contract information is incorrect (N in 1029), the process transits to the process shown in the flowchart of FIG. 20. First in the process shown in the flowchart of FIG. 20, the server 2 retrieves input error screen information from the display screen storage unit 206, and transmits the input error screen information to the user computer 3 (2001). When the user computer 3 receives the input error screen information (2002), the browser 306 of the user computer 3 displays an input error screen based on the input error screen information, on the display 305 (2003). This input error screen is substantially the same as the input error screen 1401 shown in FIG. 14. Also, the “confirm” icon 1402 is displayed on the present input error screen. Then, when the “confirm” icon 1402 is clicked by moving the icon 1403, for example, displayed on the display 305 by means of the mouse 303 so as to input information requesting a re-input (2004), the information requesting the re-input is transmitted to the server 2 (2005). When the server 2 receives this information (2006), the process transits to the step 1022 shown in FIG. 11. Thereby, the contract-information input screen is redisplayed on the display 305 of the user computer 3 so that the user can re-input the contract-information.

When it is judged that the format of the contract information is correct (Y in 1029), the server 2 stores a combination of the estimation information and the contract information in the contractor information storage unit 213 as contractor information (1030). Then, the server 2 retrieves contract completion screen information from the display screen storage unit 206, and transmits the contract completion screen information to the user computer 3 (1031). When the user computer 3 receives the contract completion screen information (1032), the user computer 3 displays a contract completion screen 2102 shown in FIG. 21, based on the contract completion screen information, on the display 305 (1033).

As described above, utilizing banter information input in the past prevents a user from frequently performing an estimation as a bantering. Additionally, in the present embodiment, only when estimation information includes a plurality of items corresponding to the formerly input banter information, the estimation information is judged to be banter information; this reduces a possibility of erroneously judging a true user as a banterer, when the user only happens to input information corresponding to the formerly input banter information.

Besides, in the present embodiment, once a user performs a bantering estimation, the user cannot receive an estimation by inputting the same information next time. To prevent this situation, estimation information may be compared with information frequently registered in the banter information storage unit 203 (for example, top-10 information registered as banter information). This is effective in actuality, because it is supposed that some users request bantering estimations to a plurality of insurance companies so as to select an insurance company with the best contract conditions.

In addition, in the present embodiment, information stored in the banter information storage unit 203 is controlled on an individual item basis. However, items included in the information may be associated with one another such that estimation information is judged to be banter information only when a combination of items included in the estimation information corresponds to a particular combination of the items, such as a combination of a name “***” and an address “+++”. This enables a further accurate banter judgment.

Further, in the present embodiment, it is checked whether or not a user inputs an incorrect address, based on zip code numbers and telephone numbers associated with address information; then, when the address is incorrect, the user is judged to be a banterer. Checking the correctness of an input address can decrease bantering estimations, because a banterer often inputs an incorrect address, as described hereinbefore.

Besides, although the present embodiment uses both the telephone number information and the zip code number information for the above-mentioned address checking, the address checking may be performed by using either of the telephone number information and the zip code number information.

[Information browsing]

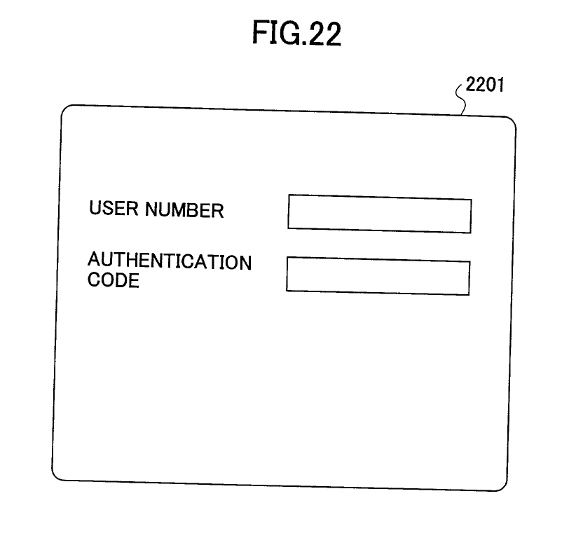

A manager of the server 2 performs a contract procedure, based on contractor information stored in the contractor information storage unit 213. A browsing operation according to the present embodiment is performed as follows: the manager accesses the server 2 by using the administration computer 4 so as to obtain the contractor information stored in the contractor information storage unit 213. In this course, requiring the manager to input information identifying the manager, such as a user number and an authentication code shown in a screen 2201 in FIG. 22, can prevent a third person from making an unauthorized access to user information and contractor information.

Additionally, in the present embodiment, the manager uses the administration computer 4 so as to obtain the contractor information. However, the server 2 may be provided with input means used by the manager to input information and displaying means for displaying the information so that the manager can directly operate the server 2 to obtain the contractor information.

Further, in addition to the above-described browsing operation, it may be arranged that the manager can update, add and delete information in the banter information storage unit 203 by operating the administration computer 4 or the server 2. This arrangement enables the banter information storage unit 203 to store banter information that cannot be recognized automatically. In this arrangement, the manager can update the information only after inputting information identifying the manager as mentioned above; this prevents an unauthorized access and update of the banter information.

The present invention is not limited to the specifically disclosed embodiments, and variations and modifications may be made without departing from the scope of the present invention.

The present application is based on Japanese priority application No. 2001-357906 filed on Nov. 22, 2001, the entire contents of which are hereby incorporated by reference.

What is claimed is:

1. An expense estimation device comprising:
storage means storing address information in association with information related to said address information;
comparing means for comparing each of items contained in estimation information with the information stored in said storage means when said estimation information is received, the items contained in said estimation information including at least address information and information related to said address information; and
judging means for judging whether or not an estimation is possible based on an association between said address information and said information related to said address information contained in said estimation information according to a result of the comparison made by said comparing means.

2. An expense estimation device comprising:
storage means storing information used upon making an estimation not leading to a contract;
comparing means for comparing each of items contained in estimation information with said information stored in said storage means when said estimation information is received; and
judging means for judging whether or not an estimation is possible based on said information stored in said storage means corresponding to at least two of said items contained in said estimation information according to a result of the comparison made by said comparing means.

3. A computer readable recording medium storing expense estimation program code for causing a computer to estimate an expense, the recording medium comprising:
comparing program code means for comparing each of items contained in estimation information with information stored by a storage means when said estimation information is received, the items contained in said estimation information including at least address information and information related to said address information; and
judging program code means for judging whether or not an estimation is possible based on an association between said address information and said information related to said address information contained in said estimation information according to a result of the comparison made by said comparing program code means.

4. A computer readable recording medium storing expense estimation program code for causing a computer to estimate an expense, the recording medium comprising:
comparing program code means for comparing each of items contained in estimation information with information stored by a storage means when said estimation information is received; and
judging program code means for judging whether or not an estimation is possible based on said information stored by said storage means corresponding to at least two of said items contained in said estimation information according to a result of the comparison made by said comparing program code means.

5. An expense estimation method for causing a computer including a storage means storing address information in association with information related to said address information to estimate an expense, the expense estimation method comprising:
a comparing step of comparing each of items contained in estimation information with the information stored in said storage means when said estimation information is received, the items contained in said estimation information including at least address information and information related to said address information; and
a judging step of judging whether or not an estimation is possible based on an association between said address information and said information related to said address information contained in said estimation information according to a result of the comparison made by said comparing step.

6. An expense estimation method for causing a computer including a storage means storing information used upon making an estimation not leading to a contract to estimate an expense, the expense estimation method comprising:
a comparing step of comparing each of items contained in estimation information with said information stored in said storage means when said estimation information is received; and
a judging step of judging whether or not an estimation is possible based on said information stored in said storage means corresponding to at least two of said items contained in said estimation information according to a result of the comparison made by said comparing step.
